(19) United States
(12) Patent Application Publication
(10) Pub. No.: US 2021/0323038 A1
(43) Pub. Date: Oct. 21, 2021

(54) REMEDIATION SIMULATOR OF DEEP PETROLEUM CONTAMINATED SOIL AND APPLICATION

(71) Applicant: XI'AN SHIYOU UNIVERSITY, Xi'an (CN)

(72) Inventors: JINLING LI, XI'AN (CN); SHIDONG ZHU, XI'AN (CN); CHENGTUN QU, XI'AN (CN); TAO YU, XI'AN (CN); BO YANG, XI'AN (CN); XIAOKANG LI, XI'AN (CN); GANG CHEN, XI'AN (CN); MINGMING DU, XI'AN (CN)

(21) Appl. No.: 17/086,738

(22) Filed: Nov. 2, 2020

(30) Foreign Application Priority Data
Dec. 31, 2019 (CN) 201911413512.X

(51) Int. Cl. B09C 1/10; B09C 1/08

(52) U.S. Cl. CPC B09C 1/10; B09C 1/08

(57) ABSTRACT

The present invention discloses a remediation simulator of deep petroleum contaminated soil and application. The remediation simulator comprises a contaminated layer box. A to-be-remedied soil sample is added to a remediation box of the contaminated layer box; uncontaminated soil is added to cylindrical tubes to provide the pressure for the contaminated soil below; feed tubes are used for feeding liquid for remedying the soil; an air compressor conveys air to the soil and pushes the liquid to diffuse. The remediation simulator of the present invention has a simple structure and simple operations, can really and effectively simulate the deep contaminated soil environment, and also evaluates and screens a method for remedying the deep petroleum contaminated soil.

### TECHNICAL FIELD

The present invention belongs to the technical field of contaminated soil remediation, and specifically, relates to a remediation simulator of deep petroleum contaminated soil and its application.

### BACKGROUND

Petroleum transportation mainly utilizes the pipeline, the road and the ocean. The widest application is the pipeline. Most of the petroleum transportation pipelines are corroded or artificially damaged as time passed; so, petroleum may leak from the pipeline and contaminate the deep soil. It is estimated that the oil and gas pipelines on the world have reached more than 2.3 million kilometers and are increasing at the speed of 40,000 to 50,000 kilometers per year. The service lives of most of the petroleum pipelines have reached 30-40 years. Therefore, the petroleum leakage problem of the petroleum transportation pipelines is more and more severe. Petroleum contaminants in the deep soil are hard to be naturally degraded, and may cause serious toxic and harmful effects to the soil organisms and the roots of plants in the soil. These contaminants may continuously migrate to enter the production and living areas of the human beings, so as to influence people's health. Therefore, it must seek a proper remediation method to solve the petroleum contamination problem of the deep soil.

At present, there are two soil remediation methods, namely, an ex-situ remediation method and an in-situ remediation method. The ex-situ remediation method has the following advantages: the contaminated soil can be integrally processed in large batch; the processing efficiency is high, and the processing effect is complete; the processing is easy to monitor, and the monitoring costs may be reduced. However, to the deep petroleum contaminated soil, the ex-situ remediation method has the disadvantages: the drilling difficulty is large, the pipeline is easy to break, the remediation costs are high, and the soil structure and ecology may be damaged. The in-situ remediation method has the advantages: influence on the environment is small, interference and damage to the contaminated site are small, the remediation method is economical and effective, and the like. There are many in-situ remediation methods for the surface soil petroleum contamination, such as soil cultivation, soil vapor extraction, soil plant remediation, and the like, but a few in-situ biologic remediation methods to the deep soil petroleum contamination. The main reason is: constituents and properties of the petroleum contaminated soil in different deep stratums are largely different. If the in-situ remediation is directly conducted, the remediation effect is poor, a large amount of resources and labors may be wasted; besides, some new toxic and harmful contaminants may be introduced into the soil to cause the secondary contamination, damage the soil structure and the ecological stability, harm the diversity of the soil organisms, increase the difficulty of the later soil ecological recovery, and also contaminate the underground water source.

### SUMMARY

To overcome the above defects of the prior art, the objective of the present invention is to propose a simply-operated, real, feasible, and effective remediation simulator of deep petroleum contaminated soil, as well as a using method of the remediation simulator and a remediation method of the deep petroleum contaminated soil, which is determined by using the remediation simulator.

A remediation simulator of deep petroleum contaminated soil is utilized to solve the above technical problems. Specifically, a contaminated layer box, an air compressor, and a peristaltic pump are arranged on a base. The interior of the contaminated layer box is divided into at least one independent remediation box by baffle plates. A drainage plate is arranged at the bottom of the remediation box. A material taking opening and a drainage tube are arranged on the front surface of the contaminated layer box corresponding to each remediation box. The drainage tube is communicated with a drainage space formed by the remediation box and the drainage plate. A cover plate is arranged on the contaminated layer box. A cylindrical tube is arranged on the cover plate corresponding to the remediation box. A feed tube is arranged in the cylindrical tube. Liquid outlets are machined in the tube wall of one end of the feed tube while the other end of the feed tube is connected with a feed port rubber plug, and the feed port rubber plug stops an inlet of the feed tube. An outlet of the air compressor is communicated with the feed tube through a diverter valve mounted on the tubing and the feed port rubber plug. An outlet of the peristaltic pump is communicated with the feed tube through a diverter valve on the tubing and the feed port rubber plug. The first mixing tank and the second mixing tank are connected with an inlet of the peristaltic pump through valves mounted on the tubing.

In the remediation simulator, preferably, one end of the feed tube is enclosed while the other end is connected with the feed port rubber plug. The enclosed end of the feed tube is inserted into the remediation box, and the liquid outlets are machined in the tube wall.

In the remediation simulator, further preferably, the same sizes of liquid outlets are machined and uniformly distributed on the tube wall of the lower end of the feed tube. At least 2-8 layers of the liquid outlets are axially arranged on the tube wall of the feed tube at an interval. The interval between every two adjacent layers of the liquid outlets is in the range of 10-20 mm, and the diameter of each liquid outlet is in the range of 1-3 mm.

In the remediation simulator, more preferably, a detection opening is formed in the material taking opening.

According to application of the remediation simulator of the present invention to the remediation of deep petroleum contaminated soil, a using method comprises: using a deep petroleum contaminated soil sample to fully fill the remediation box; covering the cover plate; fixing one end of the feed tube to the center of the deep petroleum contaminated soil sample; fixedly mounting the cylindrical tube to the cover plate; connecting the other end of the feed tube with the feed port rubber plug on the tube wall of the cylindrical tube; connecting the air compressor and the peristaltic pump with the feed port rubber plug through the tubes and the diverter valves; then, filling and compacting uncontaminated soil in the cylindrical tube; in dark place, simulating the remediation of the deep petroleum contaminated soil sample by using different remediation methods; if the petroleum content of the remedied deep petroleum contaminated soil sample is less than 1%, utilizing such method to conduct in-situ remediation on the deep petroleum contaminated soil.

When in the deep petroleum contaminated soil, the mass percent of sands is larger than 80%, the mass percent of powders is less than 15%, and the mass percent of clay particles is less than 5%, the present invention preferably selects a remediation method as follows: diluting the hydrogen peroxide with the mass concentration of 30% to 200-400 times by using water; feeding the diluted hydrogen peroxide into the deep petroleum contaminated soil through the feed tube by the peristaltic pump; meanwhile, pushing the aqueous solution of the hydrogen peroxide to diffuse over the soil by the air compressor to react for 7-14 days; feeding fresh animal-liver ground liquid, which is diluted to 3-5 times by using basic nutrient solution, into the deep petroleum contaminated soil through the feed tube by the peristaltic pump; meanwhile, pushing the diluted animal-liver ground liquid to diffuse over the soil by the air compressor to react for 48-72 hours; then, feeding a mixed liquid, including stimulating nutrient solution and composite petroleum degrading bacteria liquid with OD₆₀₀ in the range of 0.8-1.2 in the volume ratio of (1.5-2.5):1, into the deep petroleum contaminated soil through the feed tube by the peristaltic pump; meanwhile, pushing the mixed liquid to diffuse over the soil by the air compressor to conduct soil microbe remediation, such that the petroleum content of the remedied deep petroleum contaminated soil sample is less than 1%; in the remediation process, feeding the air for 20-30 minutes every day, regularly determining the water content of the deep petroleum contaminated soil, and maintaining the water content of the deep petroleum contaminated soil in the range of 24-32% by adding the basic nutrient solution.

According to the above remediation method, preferably, in each cubic decimeter of the deep petroleum contaminated soil, 80-100 mL of the hydrogen peroxide diluted to 200-400 times by using distilled water is fed; 70-90 mL of fresh animal-liver ground liquid diluted to 3-5 times by using the basic nutrient solution is fed; 110-150 mL of the mixed liquid of the stimulating nutrient solution and the composite petroleum degrading bacteria liquid is fed. The flow amount of the fed air is in the range of 60-80 L/min.

Preferably, the composite petroleum degrading bacteria liquid is prepared by respectively conducting enrichment culture on the Acinetobacter, the Pseudomonas aeruginosa, and the Achromobacter in the LB mediums for 12-18 hours; centrifuging; abandoning the supernatant, and adding normal saline 0.9% to respectively prepare bacteria liquids with the OD₆₀₀ in the range of 0.8-1.2; then, mixing the bacterial liquids according to the volume ratio of 5:5:1 to obtain the composite petroleum degrading bacteria liquid.

Preferably, the stimulating nutrient solution is prepared by adding 6-10 g of tween-80, 2-5 g of lecithin, and 15-20 g of methylene urea to the basic nutrient solution per 1000 mL.

Preferably, the basic nutrient solution is prepared by adding 9-10 g of K₂HPO₄.3H₂O, 1.5-2.5 g of NH₄Cl, 2.5-3.5 g of KH₂PO₄, 0.2-0.6 g of MgSO₄.7H₂O, 0.8-1.2 g of Na₃C₆H₅O₇.2H₂O, 0.1-0.2 g of FeSO₄.7H₂O, and 0.001-0.003 g of CaCl₂.2H₂O to the distilled water per 1000 mL.

Compared with the prior art, the present invention has the following advantages:

According to the present invention, the deep petroleum contaminated soil sample is added to the remediation box. The upper soil in the cylindrical tube provides the pressure to simulate the environmental pressure of the in-situ deep petroleum contaminated soil. The peristaltic pump feeds the bacteria liquid, the nutrient solution, and the like into the contaminated soil area through the feed tube. The air compressor helps the fed air to generate the pressure in the feed tube, so as to push the liquid in the feed tube and the soil to diffuse to the maximum extent, and feeds the air to increase the oxygen content of the soil. The remediation simulator of the present invention has low costs, is simply operated, as well as can really and effectively simulate the deep contaminated soil environment, fit for various remediation methods to evaluate the remediation effect of the deep petroleum contaminated soil, and screen in-situ remediation methods suitable for different soil textures and soil environments.

The remediation method of the present invention firstly utilizes the diluted aqueous solution of hydrogen peroxide to oxidize petroleum contaminants in the deep soil for a while, and secondly feeds the filtered fresh diluted liver ground liquid to generate reactions for a while. The liver ground liquid contains a large amount of catalase, which can deplete the rest of hydrogen peroxide in the soil such that the content of the rest of hydrogen peroxide in the soil is insufficient to damage the microbes. The liver ground liquid also provides nutrients for the microbes in the soil for the later remediation. At the meantime, a microbe enhancing and stimulating method is utilized, the Pseudomonas aeruginosa, the Achromobacter, and the Acinetobacter, which can decompose the n-paraffin, iso-paraffin, and aromatic hydrocarbons, are utilized as the composite bacteria liquid to be mixed with the stimulating nutrient solution to remedy the rest of petroleum hydrocarbon in the soil. Wherein the methylene urea in the stimulating nutrient solution is utilized as the organic nitrogen source to balance the nutritive proportion of the deep soil, is easier to be absorbed by the microbes, and facilitates the growth of the microbes. The Tween-80 can greatly elute the petroleum hydrocarbon adsorbed to the soil, enhances the contact of the microbes and the petroleum hydrocarbon, and has low toxic and harmful effects on the microbes. The lecithin as the ampholytic surfactant can emulsify the petroleum and can also provide nutrients for the microbes to enhance the degradation activity of the microbes.

Various chemicals utilized by the remediation method screened by the present invention can be quickly degraded, no new contamination and damage generate to the surrounding environment after remediation. Furthermore, the remediation method has the advantages of high efficiency, environment friendliness, simple operations, and low costs to the remedied deep petroleum contaminated soil, does not influence the surface soil ecology, and can efficiently and accurately act on the contaminated area.

### BRIEF DESCRIPTION OF THE DRAWINGS

FIG. 1 is a schematic structural diagram of an embodiment of the present invention.

FIG. 2 is an A-A sectional view of FIG. 1.

FIG. 3 is a B-B sectional view of FIG. 1.

FIG. 4 is a diagram showing a petroleum degrading effect without adding bacteria.

FIG. 5 is a diagram showing a petroleum degrading effect with bacteria.

In the drawings: 1—first mixing tank, 2—second mixing tank, 3—cylindrical tube, 4—feed port rubber plug, 5—air compressor, 6—contaminated layer box, 7—material taking opening, 8—drainage tube, 9—detecting opening, 10—peristaltic pump, 11—base, 12—feed tube, 13—cover plate, 14—drainage plate, and 15—baffle plate.

### DESCRIPTION OF THE EMBODIMENTS

The present invention will be further described in detail below with reference to the accompanying drawings and embodiments, but is not limited to these embodiments.

### Embodiment 1

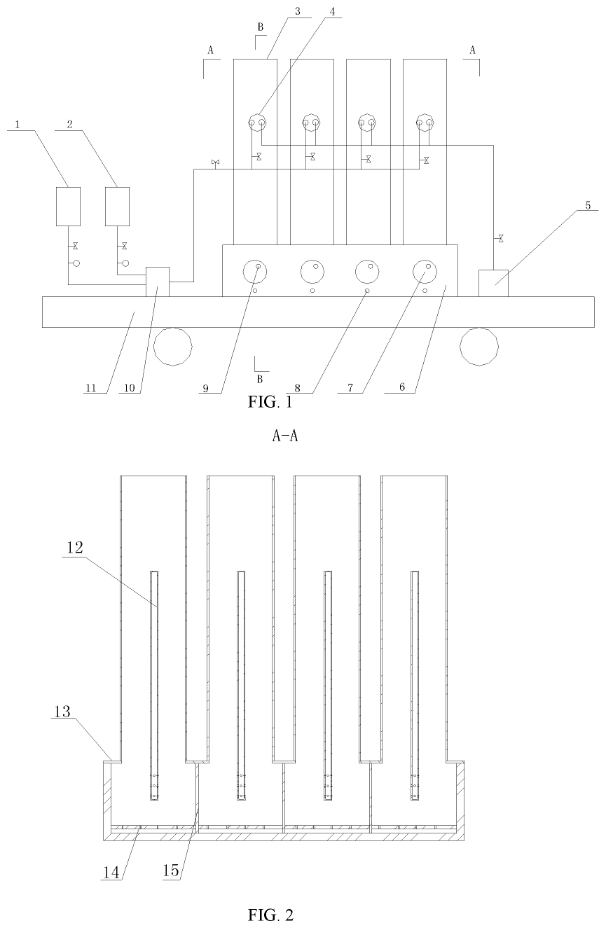

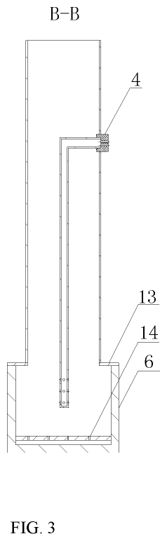

In FIG. 1 to FIG. 3, the present invention relates to a remediation simulator of deep petroleum contaminated soil. a contaminated layer box 6, an air compressor 5, and a peristaltic pump 10 are arranged on a base 11. Rollers are mounted at the bottom of the base 11 to help the remediation simulator to do reciprocating movement. The interior of the contaminated layer box 6 is divided into at least one independent remediation box by baffle plates 15. The number of the remediation boxes is determined according to the actual situation. In the embodiment, the interior of the contaminated layer box 6 is divided into four independent remediation boxes by the baffle plates 15. Each remediation box is 19 cm long, 30 cm wide, and 30 cm high. Each remediation box is filled with the petroleum contaminated soil. A drainage plate 14 is mounted at the bottom of each remediation box. Drain age holes are machined in the drainage plate 14 to drain the spare water in the petroleum contaminated soil into the bottom of the remediation box and is discharged out of the remediation simulator through a drainage tube 8. Four material taking openings 7 and four drainage tubes 8 are mounted in the front surface of the contaminated layer box 6 corresponding to the four remediation boxes. The drainage tube 8 is communicated with a drainage space formed by the remediation box and the drainage plate 14. Through the material taking opening 7, the remedied soil can be taken out to be determined. Further, a detecting opening 9 may be machined in the material taking opening 7 in the embodiment. Through the detecting opening 9, a probe of a detector is directly inserted into the remediation box to determine the remedied soil, avoiding taking the material. A cover plate 13 is mounted on the contaminated layer box 6. Four cylindrical tubes 3 are arranged on the cover plate 13 corresponding to the four remediation boxes. The number of the remediation boxes corresponds to the number of the cylindrical tubes 3, and the height and the diameter of the cylindrical tube 3 are determined according to experimental requirements. In the embodiment, four round holes corresponding to the cylindrical tubes 3 are machined in the cover plate 13. The cylindrical tubes 3 are mounted on the cover plate 13 through fastening threaded connectors. The cylindrical tube 3 is filled with the soil without petroleum, so as to provide the pressure of the upper soil layer for the petroleum contaminated soil below. With the increasing of the soil layer in the cylindrical tube 3, the pressure born by the petroleum contaminated soil is increased. Thus, the deep petroleum contaminated soil environment is really simulated. A feed tube 12 is arranged in each cylindrical tube 3. Liquid outlets are machined in one end of the feed tube 12, and the end is inserted into the soil in the remediation box; the other end of the feed tube is connected with a feed port rubber plug 4 through the tube wall of the cylindrical tube 3. Two holes are machined in the feed port rubber plug 4. A tubing communicated with the air compressor 5 and a tubing connected with the peristaltic pump 10 enter the interior of the feed tube 12 through the two holes. The feed port rubber plug 4 ensures the communication between the air compressor 5 as well as the peristaltic pump 10 with the feed tube 12. The feed tube 12 simulates the channel drilled from the surface soil layer into the contaminated soil layer. Exogenous substances can be directly added to the deep contaminated area of the soil through the feed tube 12. In the embodiment, one end of the feed tube 12 is enclosed while the other end is connected with the feed port rubber plug 4. The enclosed end of the feed tube 12 is inserted into the remediation box, and the same sizes of liquid outlets are machined and uniformly distributed on the tube wall. Five layers of liquid outlets are axially formed in the tube wall of the feed tube 12 at an interval, the interval between every two adjacent layers of liquid outlets is 20 mm, and the diameter of each liquid outlet is 2 mm. The outer wall of each liquid outlet is coated with a porous sponge layer, so as to prevent the soil from blocking the liquid outlet, and also help the exogenous substances to uniformly enter the soil.

An outlet of the air compressor 5 is respectively connected with the four feed port rubber plugs 4 through a diverter valve mounted on the tubing. The air compressor 5 can convey the air into the deep soil through the feed tubes 12 to increase the oxygen content of the soil and also to provide a certain pressure for the liquid in the feed tubes 12, so as to compress the liquid in the feed tubes 12 to widely permeate into the contaminated area. An outlet of the peristaltic pump 10 is respectively connected with the four feed port rubber plugs 4 through a diverter valve mounted on the tubing. The liquid in the peristaltic pump 10 enters the soil in the remediation boxes through the feed tubes 12. In the present invention, independent values are mounted on the separate tubes of the air compressor 5 and the peristaltic pump 10 to control the flowing of the liquid and the air in the four remediation boxes. The first mixing tank 1 and the second mixing tank 2 are connected with the inlet of the peristaltic pump 10 through valves and flow meters mounted on the tubes. The first mixing tank 1 and the second mixing tank 2 are used for containing different liquids.

### Embodiment 2

In the embodiment, two layers of liquid outlets are axially formed in the tube wall of the feed tube 12 at an interval, the interval between the two layers of liquid outlets is 10 mm, and the diameter of each liquid outlet is 1 mm. The other components and their connection relationships in the embodiment are completely the same as them in Embodiment 1.

### Embodiment 3

In the embodiment, eight layers of liquid outlets are axially formed in the tube wall of the feed tube 12 at an interval, the interval between every two adjacent layers of liquid outlets is 20 mm, and the diameter of each liquid outlet is 3 mm. The other components and their connection relationships in the embodiment are completely the same as them in Embodiment 1.

### Embodiment 4

Application of the remediation simulator of Embodiment 1 to the remediation of deep petroleum contaminated soil

A deep petroleum contaminated soil sample (in which the mass percent of sands is 82.3%, the mass percent of powders is 13.4%, and the mass percent of clay particles is 4.3%) fully fills the four remediation boxes, respectively. The four remediation boxes are numbered in order. The cover plate 13 covers the remediation boxes. One end, having the liquid outlets, of the tube wall of each feed tube 12 is fixed to the center of the deep petroleum contaminated soil sample. The cylindrical tube (3) is fixedly mounted to the cover plate 13. The other end of the feed tube 12 is connected with the feed port rubber plug 4 on the tube wall of the cylindrical tube 3. The air compressor 5 and the peristaltic pump 10 are connected with the feed port rubber plugs 4 through the tubes and the diverter valves. Then, uncontaminated soil are filled in the cylindrical tubes 3 to be compacted. In dark place, the deep petroleum contaminated soil sample in the four remediation boxes is remedied by using the following method. The specific remediation method is as follows:

In the first remediation box: adding distilled water to maintain the water content in the contaminated soil in the range of 24-32%.

In the second remediation box: diluting 6 ml of the hydrogen peroxide with the mass concentration of 30% by using 1600 ml of the distilled water; feeding the diluted hydrogen peroxide into the contaminated soil by the peristaltic pump 10; further pushing the aqueous solution of the hydrogen peroxide to diffuse over the contaminated soil by the air compressor 5 to react for 7 days; then, adding the distilled water to maintain the water content in the contaminated soil in the range of 24-32%.

In the third remediation box: diluting 6 ml of the hydrogen peroxide with the mass concentration of 30% by using 1600 ml of the distilled water; feeding the diluted hydrogen peroxide into the contaminated soil by the peristaltic pump 10; further pushing the aqueous solution of the hydrogen peroxide to diffuse over the contaminated soil by the air compressor 5 to react for 7 days; mixing 300 ml of fresh animal-liver ground liquid with 1100 ml of the distilled water; filtering the mixed liquid by a gauze; feeding the filtered mixed liquid into the contaminated soil by the peristaltic pump 10 and pushing it to diffuse over the contaminated soil by the air compressor 5 to react for 48 hours; adding 800 ml of composite petroleum degrading bacteria liquid to 1200 ml of the distilled water; fully mixing; feeding the mixed liquid into the contaminated soil by the peristaltic pump 10 and pushing it to diffuse over the contaminated soil by the air compressor 5; standing for 24 hours; determining the water content of the soil; adding the distilled water to maintain the water content in the contaminated soil in the range of 24-32%.

In the fourth remediation box: diluting 6 ml of the hydrogen peroxide with the mass concentration of 30% by using 1600 ml of the distilled water; feeding the diluted hydrogen peroxide into the contaminated soil by the peristaltic pump 10; further pushing the aqueous solution of the hydrogen peroxide to diffuse over the contaminated soil by the air compressor 5 to react for 7 days; mixing 300 ml of fresh animal-liver ground liquid with 1100 ml of basic nutrient solution; filtering the mixed liquid by a gauze; feeding the filtered mixed liquid into the contaminated soil by the peristaltic pump 10 and pushing it to diffuse over the contaminated soil by the air compressor 5 to react for 48 hours; adding 800 ml of composite petroleum degrading bacteria liquid to 1200 ml of stimulating nutrient solution; fully mixing; feeding the mixed liquid into the contaminated soil by the peristaltic pump 10 and pushing it to diffuse over the contaminated soil by the air compressor 5; standing for 24 hours; determining the water content of the soil; adding the stimulating nutrient solution to maintain the water content in the contaminated soil in the range of 24-32%.

The basic nutrient solution is prepared by adding 9 g of K₂HPO₄.3H₂O, 2 g of NH₄Cl, 3 g of KH₂PO₄, 0.4 g of MgSO₄.7H₂O, 1 g of Na₃C₆H₅O₇.2H₂O, 0.2 g of FeSO₄.7H₂O, and 0.002 g of CaCl₂.2H₂O to the distilled water per 1000 ml. The stimulating nutrient solution is prepared by adding 7 g of tween-80, 3.5 g of lecithin, and 15 g of methylene urea to the basic nutrient solution per 1000 ml. The composite petroleum degrading bacteria liquid is prepared by respectively conducting enrichment culture on the Acinetobacter, the Pseudomonas aeruginosa, and the Achromobacter in the LB mediums (which is prepared by adding 10 g of peptone, 10 g of NaCl, 5 g of yeast extract powder, and 20 g of agar powder to the distilled water per 1000 ml, and its pH value is equal to 7.2) for 12-18 hours; centrifuging; abandoning the supernatant, and adding normal saline 0.9% to respectively prepare bacteria liquids with the OD₆₀₀ equal to 1.2; then, mixing the bacterial liquids according to the volume ratio of 5:5:1 to obtain the composite petroleum degrading bacteria liquid.

After the contaminated soil is remedied by the above four remediation methods, the air is fed for 20 minutes every day; variation of the oxygen content is observed by a soil oxygen meter; the water content, the oxygen content, the temperature, and the humidity of the contaminated soil, as well as the soil petroleum hydrocarbon degradation rate, are regularly determined. Thus, the environment required by the growth of living beings can be greatly handled, and the data change can be monitored any time. Monitoring data in the petroleum contaminated soil remediation process is as follows:

TABLE 1
Variation of the oxygen content (%) of the
contaminated soil after feeding the air

| | First | Second | Third | Fourth |
|---|---|---|---|---|
| Time | remediation | remediation | remediation | remediation |
| (hour) | box | box | box | box |
| 0 | 18.2 | 18.3 | 18 | 18.2 |
| 5 | 17.4 | 17.5 | 17.2 | 17.7 |
| 10 | 16.9 | 16.8 | 16.3 | 17.0 |
| 15 | 16.3 | 16.2 | 15.7 | 16.4 |
| 20 | 15.5 | 15.6 | 15.3 | 15.7 |
| 25 | 15.1 | 15.3 | 14.9 | 15.0 |

Based on Table 1, it can be seen that the oxygen content of the contaminated soil in the four remediation boxes is about 18% in maximum and 15% in minimum, and the variation amplitude is about 3%. Furthermore, when the air is fed for 20 minutes, the oxygen content in the contaminated soil reaches about 18% and is not increased. However, the air content in the contaminated soil is reduced to the lowest value when the air is fed for 25 hours. Therefore, for saving the costs, the time of feeding the air in the experiment can be determined to 20 minutes, and the time space is 24 hours.

TABLE 2
Degradation rate of petroleum hydrocarbon in the contaminated
soil by using different remediation methods

| | | Petroleum | |
|---|---|---|---|
| Experiment | Experiment | concentration | Degradation |
| condition | time (day) | mg/kg | rate % |
| First | 0 | 37507.33 | 0.00 |
| remediation box | 18 | 36560.00 | 2.53 |
| | 36 | 35349.33 | 5.75 |
| | 54 | 33306.00 | 11.20 |
| | 70 | 31413.33 | 16.25 |
| Second | 0 | 37456.00 | 0.00 |
| remediation box | 18 | 26851.00 | 28.31 |
| | 36 | 25543.33 | 31.80 |
| | 54 | 25543.33 | 34.10 |
| | 70 | 23876.67 | 36.25 |
| Third | 0 | 37492.33 | 0.00 |
| remediation box | 18 | 28282.67 | 24.56 |
| | 36 | 24523.73 | 34.59 |
| | 54 | 21944.26 | 41.47 |
| | 70 | 19518.51 | 47.94 |
| Fourth | 0 | 37497.00 | 0.00 |
| remediation box | 18 | 23173.15 | 38.20 |
| | 36 | 15028.79 | 59.92 |
| | 54 | 10930.37 | 70.85 |
| | 70 | 6838.67 | 81.76 |

Based on Table 2, it can be seen that the degradation rates of petroleum hydrocarbon in the contaminated soil from the first remediation box to the second remediation box are sequentially increased, representing that the naturally remedied and degraded contaminated soil in the first remediation box under natural conditions is hard to meet the expected requirement. If the remediation stimulator of the present invention and the remediation method of the fourth remediation box are utilized to conduct biologic contamination simulation and remediation on the contaminated soil, the degradation rate of petroleum hydrocarbon can be up to 81.76%.

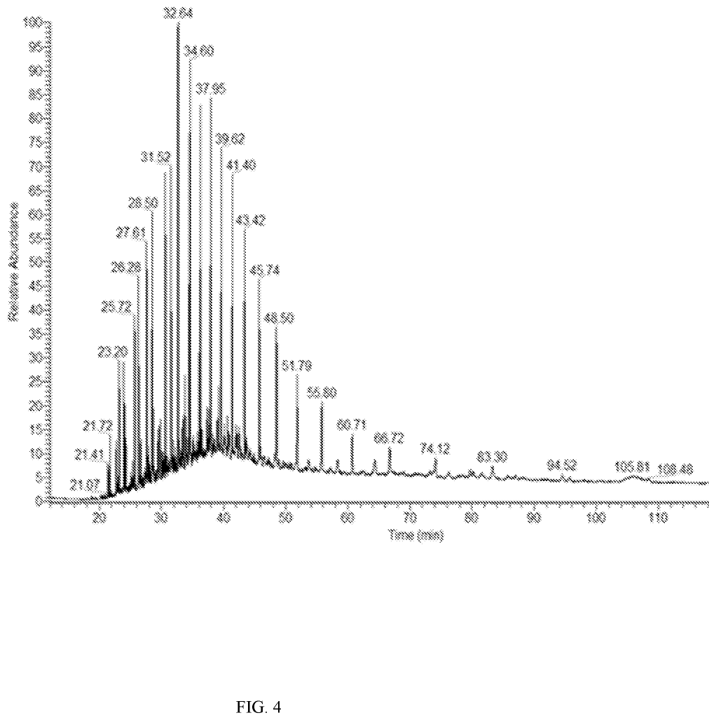

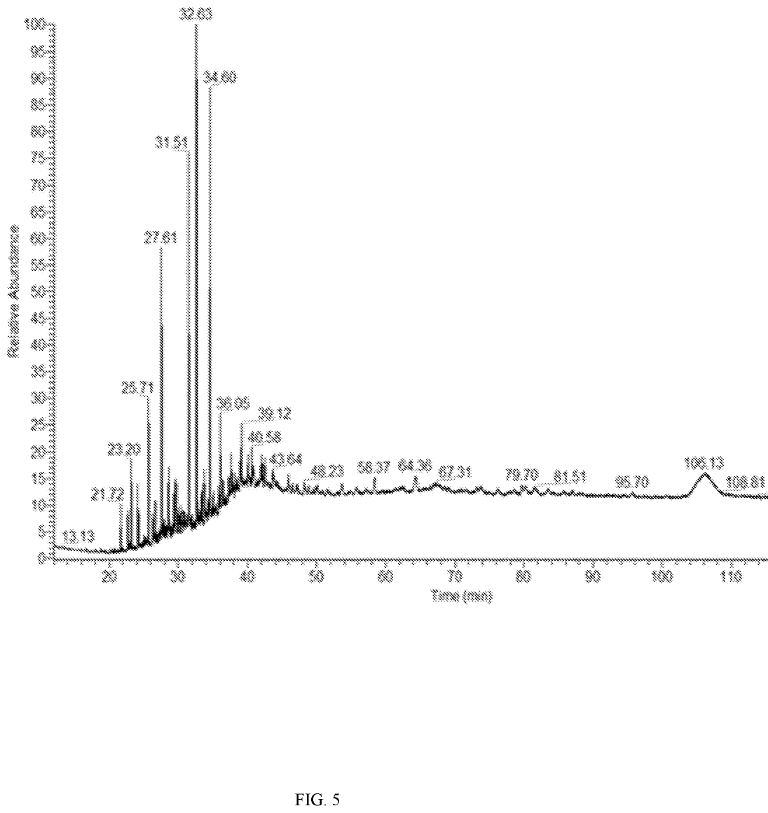

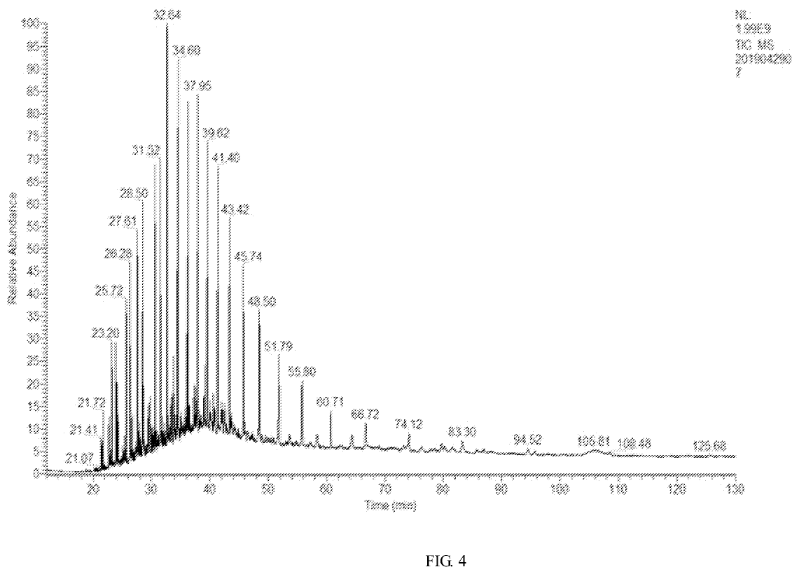

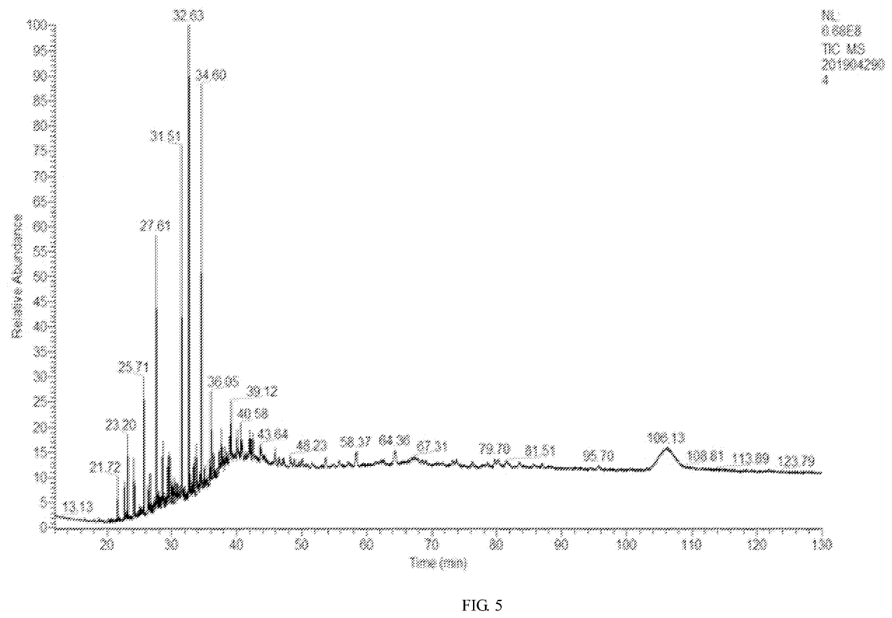

Based on FIG. 4 and FIG. 5, it can be seen that the composite bacterial liquid can degrade most of the petroleum hydrocarbons in a short time after the composite bacterial liquid (including the Acinetobacter, the Pseudomonas aeruginosa, and the Achromobacter) is degraded for 7 days. The n-paraffin in the petroleum is completely degraded after 7 days. The iso-paraffin and the other high-molecular hydrocarbons are also remarkably degraded. Therefore, such composite bacterial liquid has a great degradation effect to the petroleum.

What is claimed is:

1. A remediation simulator of deep petroleum contaminated soil, wherein a contaminated layer box (6), an air compressor (5), and a peristaltic pump (10) are arranged on a base (11); the interior of the contaminated layer box (6) is divided into at least one independent remediation box by baffle plates (15); a drainage plate (14) is arranged at the bottom of the remediation box; a material taking opening (7) and a drainage tube (8) are arranged on the front surface of the contaminated layer box (6) corresponding to each remediation box; the drainage tube (8) is communicated with a drainage space formed by the remediation box and the drainage plate (14); a cover plate (13) is arranged on the contaminated layer box (6); a cylindrical tube (3) is arranged on the cover plate (13) corresponding to the remediation box; a feed tube (12) is arranged in the cylindrical tube (3); liquid outlets are machined in the tube wall of one end of the feed tube (12) while the other end of the feed tube is connected with a feed port rubber plug (4), and the feed port rubber plug (4) stops an inlet of the feed tube (12); an outlet of the air compressor (5) is communicated with the feed tube (12) through a diverter valve mounted on the tubing and the feed port rubber plug (4); an outlet of the peristaltic pump (10) is communicated with the feed tube (12) through a diverter valve on the tubing and the feed port rubber plug (4); the first mixing tank (1) and the second mixing tank (2) are connected with an inlet of the peristaltic pump (10) through valves mounted on the tubing.

2. The remediation simulator of deep petroleum contaminated soil according to claim 1, wherein one end of the feed tube (12) is enclosed while the other end is connected with the feed port rubber plug (4); the enclosed end of the feed tube (12) is inserted into the remediation box, and the liquid outlets are machined in the tube wall.

3. The remediation simulator of deep petroleum contaminated soil according to claim 2, wherein the same sizes of liquid outlets are machined and uniformly distributed on the tube wall of the lower end of the feed tube (12); at least 2-8 layers of the liquid outlets are axially arranged on the tube wall of the feed tube (12) at an interval; the interval between every two adjacent layers of the liquid outlets is in the range of 10-20 mm, and the diameter of each liquid outlet is in the range of 1-3 mm.

4. The remediation simulator of deep petroleum contaminated soil according to claim 1, wherein a detection opening (9) is formed in the material taking opening (7).

5. Application of the remediation simulator according to claim 1 to the remediation of deep petroleum contaminated soil, wherein its using method comprises: using a deep petroleum contaminated soil sample to fully fill the remediation box; covering the cover plate (13); fixing one end of the feed tube (12) to the center of the deep petroleum contaminated soil sample; fixedly mounting the cylindrical tube (3) to the cover plate (13); connecting the other end of the feed tube (12) with the feed port rubber plug (4) on the tube wall of the cylindrical tube (3); connecting the air compressor (5) and the peristaltic pump (10) with the feed port rubber plug (4) through the tubes and the diverter valves; then, filling and compacting uncontaminated soil in the cylindrical tube (3); in dark place, simulating the remediation of the deep petroleum contaminated soil sample by using different remediation methods; if the petroleum content of the remedied deep petroleum contaminated soil sample is less than 1%, utilizing such method to conduct in-situ remediation on the deep petroleum contaminated soil.

6. Application of the remediation simulator to the remediation of deep petroleum contaminated soil according to claim 5, wherein, when in the deep petroleum contaminated soil, the mass percent of sands is larger than 80%, the mass percent of powders is less than 15%, and the mass percent of clay particles is less than 5%, the remediation method of the deep petroleum contaminated soil comprises the steps: diluting the hydrogen peroxide with the mass concentration of 30% to 200-400 times by using water; feeding the diluted hydrogen peroxide into the deep petroleum contaminated soil through the feed tube (12) by the peristaltic pump (10); meanwhile, pushing the aqueous solution of the hydrogen peroxide to diffuse over the soil by the air compressor (5) to react for 7-14 days; feeding fresh animal-liver ground liquid, which is diluted to 3-5 times by using basic nutrient solution, into the deep petroleum contaminated soil through the feed tube (12) by the peristaltic pump (10); meanwhile, pushing the diluted animal-liver ground liquid to diffuse over the soil by the air compressor (5) to react for 48-72 hours; then, feeding a mixed liquid, including stimulating nutrient solution and composite petroleum degrading bacteria liquid with OD600 in the range of 0.8-1.2 in the volume ratio of (1.5-2.5):1, into the deep petroleum contaminated soil through the feed tube (12) by the peristaltic pump (10); meanwhile, pushing the mixed liquid to diffuse over the soil by the air compressor (5) to conduct soil microbe remediation, such that the petroleum content of the remedied deep petroleum contaminated soil sample is less than 1%; in the remediation process, feeding the air for 20-30 minutes every day, regularly determining the water content of the deep petroleum contaminated soil, and maintaining the water content of the deep petroleum contaminated soil in the range of 24-32% by adding the basic nutrient solution;
according to the above remediation method, in each cubic decimeter of the deep petroleum contaminated soil, 80-100 ml of the hydrogen peroxide diluted to 200-400 times by using distilled water is fed; 70-90 ml of fresh animal-liver ground liquid diluted to 3-5 times by using the basic nutrient solution is fed; 110-150 ml of the mixed liquid of the stimulating nutrient solution and the composite petroleum degrading bacteria liquid is fed; the flow amount of the fed air is in the range of 60-80 L/min.

7. Application of the remediation simulator to the remediation of deep petroleum contaminated soil according to claim 6, wherein the composite petroleum degrading bacteria liquid is prepared by respectively conducting enrichment culture on the Acinetobacter, the Pseudomonas aeruginosa, and the Achromobacter in the LB mediums for 12-18 hours; centrifuging; abandoning the supernatant, and adding normal saline 0.9% to respectively prepare bacteria liquids with the OD₆₀₀ in the range of 0.8-1.2; then, mixing the bacterial liquids according to the volume ratio of 5:5:1 to obtain the composite petroleum degrading bacteria liquid.

8. Application of the remediation simulator to the remediation of deep petroleum contaminated soil according to claim 6, wherein the stimulating nutrient solution is prepared by adding 6-10 g of tween-80, 2-5 g of lecithin, and 15-20 g of methylene urea to the basic nutrient solution per 1000 ml.

9. Application of the remediation simulator to the remediation of deep petroleum contaminated soil according to claim 8, wherein the basic nutrient solution is prepared by adding 9-10 g of K₂HPO₄.3H₂O, 1.5-2.5 g of NH₄Cl, 2.5-3.5 g of KH₂PO₄, 0.2-0.6 g of MgSO₄.7H₂O, 0.8-1.2 g of Na₃C₆H₅O₇.2H₂O, 0.1-0.2 g of FeSO₄.7H₂O, and 0.001-0.003 g of CaCl₂.2H₂O to the distilled water per 1000 mL.

10. Application of the remediation simulator to the remediation of deep petroleum contaminated soil according to claim 8, wherein the basic nutrient solution is prepared by adding 9-10 g of K₂HPO₄.3H₂O, 1.5-2.5 g of NH₄Cl, 2.5-3.5 g of KH₂PO₄, 0.2-0.6 g of MgSO₄.7H₂O, 0.8-1.2 g of Na₃C₆H₅O₇.2H₂O, 0.1-0.2 g of FeSO₄.7H₂O, and 0.001-0.003 g of CaCl₂.2H₂O to the distilled water per 1000 mL.
